(19) United States
(12) Patent Application Publication
(10) Pub. No.: US 2004/0129515 A1
(43) Pub. Date: Jul. 8, 2004

(54) Cushioning body

(76) Inventor: Hideaki Murakami, Hyogo (JP)

Correspondence Address: BIRCH STEWART KOLASCH & BIRCH, PO BOX 747, FALLS CHURCH, VA, 22040-0747, US

(21) Appl. No.: 10/698,481

(22) Filed: Nov. 3, 2003

(30) Foreign Application Priority Data
Jan. 8, 2003 (JP) 2003-002272

(51) Int. Cl. F16F 9/53

(52) U.S. Cl. 188/267.2

(57) ABSTRACT

A cushioning body is made by molding a mixture of shock absorbing gel (heat resistant elastic member) made of polyurethane resin and ferrite particles (electromagnetic wave blocking members) into a box. Since the shock absorbing gel is in a form of gel, it does not have fluidity but has stability in shape, and further has not only shock absorbing ability but also heat resistance and heat radiation ability deriving from thermal conductivity. The ferrite particles are locally distributed on a main board side of a bottom portion of the cushioning body and have an electromagnetic wave blocking ability by absorbing or reflecting the electromagnetic wave to prevent transmittance of the electromagnetic wave.

### BACKGROUND OF THE INVENTION

1. Field of the Invention

The present invention relates to a cushioning body which is arranged for use around an electromagnetic wave generating unit, for example, such as a hard disk drive (hereinafter referred to as “HDD”) device or the like.

2. Description of the Related Art

In recent years, an HDD device to memorize a program and data has been used for a vehicle mounted navigation system (hereinafter referred to as “NAVI”) and a vehicle mounted audio device such as a compressed audio system and in some cases it may be affected by vibrations during driving of the vehicle and heat generated by itself. For this reason, in the conventional NAVI and audio device, for example, a main board is arranged on an inside bottom surface of a box shaped outside cell, and supports which are passing through holes of this main board, are erected on the inside bottom surface of the outside cell, and an inside cell is fixed to these supports with its opening facing downward, and a cushioning body constituted of a shock absorbing member of a spring, a damper or the like, which are fixed to the inside wall of this inside cell, separates a mechanism body including the HDD device, thereby preventing the HDD device from being affected by the vibrations and the heat is attained.

However, in a case where the HDD device is arranged near above the main board of the NAVI and the audio device, an electromagnetic wave (radiation noise) generated by the HDD device itself sometimes affects the main board. In this case, the electromagnetic wave has a detrimental effect on the position measurement in the NAVI and sound quality and noises in the audio device.

There have been known materials for absorbing energy of the electromagnetic wave however, publicly known electromagnetic wave absorbing materials are expensive and hard to be molded (for example, refer to patent document 1). [Patent document ] Japanese Unexamined Patent Publication No. 58-24757

Thus, it can eliminate the effect of vibrations and heat but cannot block the electromagnetic wave (radiation noise), because the conventional cushioning body is structured in the manner described above, so it presents a problem that it cannot prevent the malfunction of the NAVI and the audio device.

### SUMMARY OF THE INVENTION

The present invention has been made to solve the above mentioned problem. It is an object of the present invention to provide a cushioning body capable of surely eliminating the effect of vibrations and heat and at the same time surely blocking the electromagnetic wave (radiation noise).

A cushioning body in accordance with the present invention is made to include a heat resistant elastic member arranged around an electromagnetic wave generating unit; and an electromagnetic wave blocking member arranged in the heat resistant elastic member.

Therefore, according to the present invention, it is possible to produce an effect of surely eliminating the effect of vibrations and heat by the heat resistant elastic member and at the same time surely blocking the electromagnetic wave (radiation noise) by the electromagnetic wave blocking member.

### BRIEF DESCRIPTION OF THE DRAWINGS

FIG. 1 is a schematic sectional view to show the structure of a cushioning body in accordance with embodiment 1 of the present invention.

FIG. 2 is a schematic sectional view to show relevant portion A in FIG. 1 on an enlarged scale.

FIG. 3 is a schematic sectional view to show the structure of a cushioning body in accordance with embodiment 2 of the present invention.

FIG. 4 is a schematic sectional view to show the structure of a cushioning body in accordance with embodiment 3 of the present invention.

FIG. 5 is a schematic sectional view to show the structure of a cushioning body in accordance with embodiment 4 of the present invention.

FIG. 6 is a schematic sectional view to show relevant portion D in FIG. 5 on an enlarged scale.

FIG. 7 is a schematic sectional view to show the structure of a cushioning body in accordance with embodiment 5 of the present invention.

### DETAILED DESCRIPTION OF THE PREFERRED EMBODIMENTS

The preferred embodiments of the present invention will be described below.

### EMBODIMENT 1

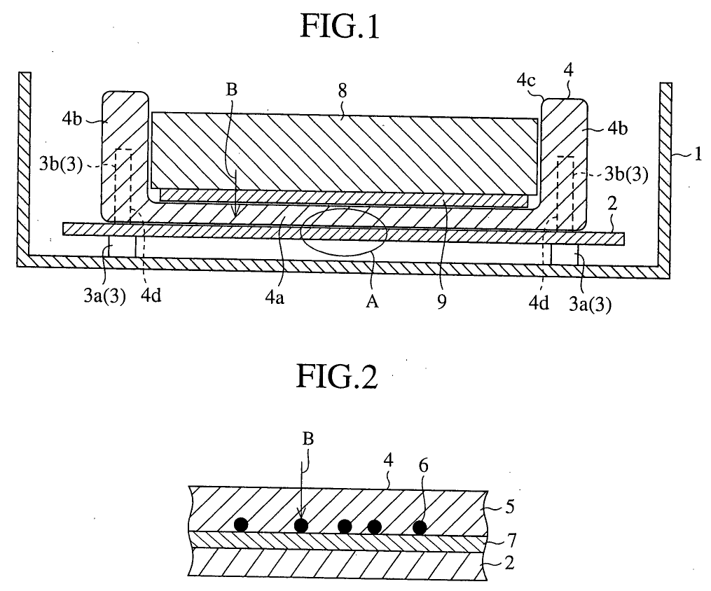

FIG. 1 is a schematic sectional view to show the structure of a cushioning body in accordance with embodiment 1 of the present invention. FIG. 2 is a schematic sectional view to show relevant portion A in FIG. 1 on an enlarged scale.

A box shaped outside cell 1 constitutes a chassis which covers a set of electric unit such as a navigation system (not shown), an audio system (not shown) and the like. On the inside bottom surface of this outside cell 1 are erected supports 3 for supporting a main board 2 which has a control circuit (not shown) of the above mentioned set of electric unit. Each of the supports 3 is structured of a large diameter portion 3a and a small diameter portion 3b which is formed above the large diameter portion 3a. In the main board 2 are formed through holes (not shown), and each of through holes has the small diameter portion 3b of the support 3 passed through. Then, the main board 2 is placed on an end surface on the small diameter portion 3b side of the large diameter portion 3a adjacent to the small diameter portion 3b which passes through the hole (not shown).

A cushioning body 4 is formed in a box which is schematically structured of a bottom portion 4a, a plurality of walls 4b each erected on an edge portion of this bottom portion 4a, and an opening 4c formed by these walls 4b. In the wall 4b of the cushioning body 4 are formed holes 4d each of which has the small diameter portions 3b of the support 3 inserted into. Such a cushioning body 4 is made by forming a mixture of shock absorbing gel (heat resistant elastic member) 5 made of polyurethane resin and ferrite particles (electromagnetic wave blocking member) 6 into a box. Since the shock absorbing gel 5 is in a form of gel, it does not have fluidity but has stability in shape and at the same time it has not only shock absorbing ability but also heat resistance and heat radiation ability derived from thermal conductivity. On the other hand, the ferrite particles 6 are arranged to be locally distributed on the main board 2 side (lower side) of the bottom portion 4a of the cushioning body 4 in this embodiment 1 and have an electromagnetic wave blocking ability of absorbing or reflecting an electromagnetic wave and preventing the electromagnetic wave from passing through the bottom portion 4a. The mixture of the shock absorbing gel 5 and the ferrite particles 6 is made to have characteristics of the both materials and is prepared by mixing the shock absorbing gel 5 with the ferrite particles 6 in a range of from 30% to 60% by weight. At this point, in a case where the mixture contains less than 30 weight % of ferrite particles 6, it does not have a sufficient effect of blocking the electromagnetic wave and thus can not surely prevent the electromagnetic wave from having an influence on the above mentioned main board 2, whereas in a case where the mixture contains more than 60 weight % of ferrite particles 6, it has a sufficient effect of blocking the electromagnetic wave but presents another problem of derogation in the shock absorbing ability of the shock absorbing gel 5.

Further, a coating layer 7 for covering the ferrite particles 6 that are locally distributed on and protruded to the main board 2 side is provided on the lower surface of the bottom portion 4a of the cushioning body 4. The coating layer 7 is arranged to have enough thickness to cover the protruding portions of the ferrite particles 6. As for a material for forming the coating layer 7, any material can be used as far as it has an electrical insulating ability in order to prevent the main board 2 from developing a short circuit, because the cushioning body 4 is directly placed on the main board 2. For example, the polyurethane resin which constitutes the above mentioned shock absorbing gel 5 can be used as the material for forming the coating layer 7.

Still further, the cushioning body 4 is directly placed on the main board 2 in a state where the small diameter portions 3b of the supports 3 are passed through the holes 4d thereof. An HDD device 8 of the above mentioned electronic unit set is contained inside the bottom portion 4a of the cushioning body 4. A sub board 9 which has a control circuit (not shown) to control the HDD device 8 is fixed to the bottom surface of the HDD device 8.

Next, one example of a manufacturing method of the cushioning body 4 in this embodiment will be described.

First, the ferrite particles 6 is dispersedly mixed and kneaded with the shock absorbing gel 5 by use of a device such as a kneader or the like. Then, the mixture of the shock absorbing gel 5 and the ferrite particles 6 is poured into a box shaped mold and only the ferrite particles 6 are deposited by means of a difference in specific gravity between the shock absorbing gel 5 and the ferrite particles 6, whereby the ferrite particles 6 are locally distributed on the main board 2 side (lower side) of a portion to be the bottom portion 4a of the cushioning body 4 (sedimentation method). Next, the cushioning body 4 is formed in the box, as described above, and then the coating layer 7 is provided on the lower surface of its bottom portion 4a to produce the cushioning body 4 as shown in FIG. 2.

Next, operation will be described.

The electromagnetic wave (directed in a direction shown by an arrow B in FIG. 2) generated by the HDD device 8 arranged in the cushioning body 4, impinges on the ferrite particles 6 on the main board 2 side of the cushioning body 4 where the ferrite particles 6 are densely distributed, thereby being absorbed or reflected by the ferrite particles 6. Thus, the electromagnetic wave is blocked by the cushioning body 4, thereby being prevented from arriving at the main board 2. Further, the coating layer 7 prevents a short circuit between the conductive ferrite particles 6 which are partially protruding from the lower surface of the bottom portion 4a of the cushioning body 4 and the wiring (not shown) of the main board 2.

Moreover, the cushioning body 4 protects the HHD device 8 from shock caused by vibrations during driving of the vehicle by means of its shock absorbing ability and quickly radiates heat generated by the HHD device 8 by means of its thermal conductivity, so that the HDD device 8 is not affected by the heat generated by itself. In addition, since the cushioning body 4 has heat resistance, it is not deformed by the heat generated by the HDD device 8 but surely holds the HDD device 8.

As described above, according to this embodiment 1, the cushioning body 4 is so arranged that the ferrite particles 6 are dispersedly distributed in the shock absorbing gel 5. Thus, this embodiment 1 produces an effect of surely eliminating the influence of vibrations and heat by the shock absorbing gel 5 and at the same time an effect of surely blocking the electromagnetic wave generated by the HDD device 8 which is arranged in the cushioning body 4 by the ferrite particles 6. Therefore, this embodiment 1 produces an effect of surely eliminating the influence of the electromagnetic wave on the main board 2 which is arranged directly below the HDD device 8.

According to this embodiment 1, the cushioning body 4 is so arranged that the ferrite particles 6 are locally distributed in the shock absorbing gel 5 thereby to increase the distribution density of the ferrite particles 6. Thus, this embodiment 1 produces an effect of enhancing an effect of blocking the electromagnetic wave.

At this point, the ferrite particles 6 are locally distributed by the sedimentation method in the manufacturing method of the cushioning body 4 in this embodiment 1, but it is also recommended that the ferrite particles 6 be locally distributed, for example, by a magnetic attraction method using a magnet. That is, in the magnetic attraction method, the ferrite particles 6 are dispersed and mixed in the shock absorbing gel 5; thereafter, the ferrite particles 6 are gathered by the magnet in a preceding step of molding; and after molding, the ferrite particles 6 are demagnetized. According to this magnetic attraction method, for example, in a case where the electromagnetic wave is generated in a specified position of the HDD device 8, it is possible to densely distribute the ferrite particles 6 in a corresponding portion of the cushioning body 4 close to the specified position and in the vicinity of the portion. This arrangement of the ferrite particles 6 produces an effect of enhancing the effectiveness of shielding the main board 2 from the electromagnetic wave. In a structure where the cushioning body 4 is directly placed on the main board 2, this magnetic attraction method is also effective for locally distributing the ferrite particles 6 on the HDD device 8 side of the cushioning body 4, which is separated from the main board 2. Incidentally, in this case, it is not necessary to provide the coating layer 7 on the lower surface of the bottom portion 4a of the cushioning body 4, so it is possible to produce an effect of reducing a manufacturing process and hence reducing manufacturing cost.

### EMBODIMENT 2

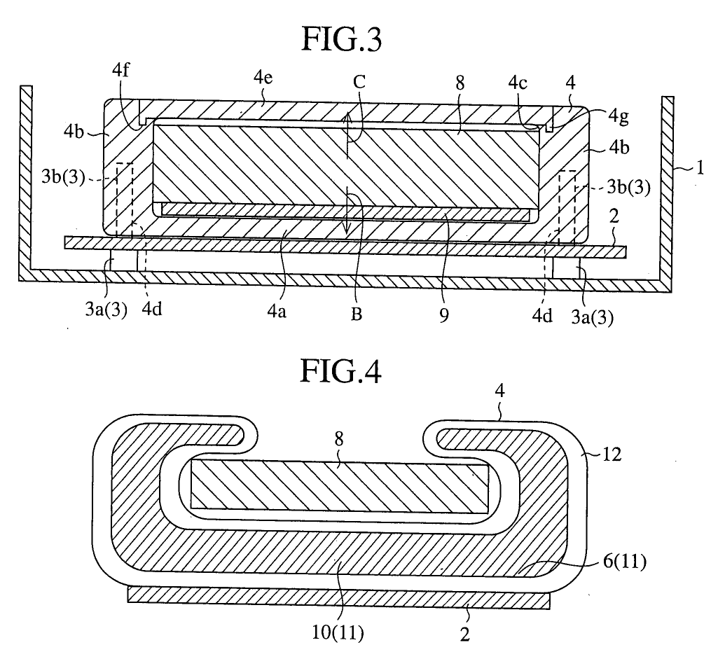

FIG. 3 is a schematic sectional view to show the structure of a cushioning body in accordance with embodiment 2 of the present invention. Here, of the constituent elements of this embodiment 2, elements common to the constituent elements of the embodiment 1 are denoted by the same reference symbols and their further descriptions will be omitted.

The feature of this embodiment 2 lies in that different from the lidless box shaped cushioning body 4 in the embodiment 1, the cushioning body 4 is formed in a box with lid to cover the whole of HDD device 8. That is, the cushioning body 4 has a ceiling part 4e that is removably fitted in and engaged with the top of wall 4b constituting the opening 4c and closes the opening 4c. A depressed portion 4f is formed on the top of the wall 4b and a protruding portion 4g to be engaged with the depressed portion 4f is formed on the lower peripheral edge of the ceiling part 4e. At this point, the reason why the ceiling part 4e is provided, is to surely eliminate a possibility that when the top of the cushioning body 4 is open like the embodiment 1, the electromagnetic wave generated by the HDD device 8 passes from the opening 4c around the outside and may have an influence on the main board 2 or a board of the other device (not shown) arranged on an extending direction of the opening 4c. Moreover, in the cushioning body 4 in accordance with this embodiment 2, the ferrite particles 6 are uniformly dispersed in the shock absorbing gel 5 and the coating layer (not shown) is provided on the lower surface of its bottom portion 4a, so that the cushioning body 4 can be directly arranged on the main board 2.

Next, one example of a manufacturing method of the cushioning body 4 in this embodiment will be described.

First, the ferrite particles 6 is dispersedly mixed and kneaded with the shock absorbing gel 5 by use of a device such as a kneader or the like. Next, the mixture is poured into a box shaped mold to form a box shaped body having the bottom portion 4a, the wall 4b and the opening 4c, and the ceiling part 4e is separately formed which is fitted in and engaged with the top of the wall 4b constituting the opening 4c. Thereafter, the coating layer (not shown) is formed on the lower surface of the bottom portion 4a to produce the cushioning body 4.

Next, operation will be described.

The electromagnetic wave (directed in a direction shown by an arrow B in FIG. 3) generated by the HDD device 8 which is arranged in the cushioning body 4, impinges on the ferrite particles 6 uniformly dispersed in the cushioning body 4, thereby being absorbed or reflected by the ferrite particles 6. Thus, the electromagnetic wave is blocked by the cushioning body 4, thereby being prevented from arriving at the main board 2. In particular, the ceiling part 4e of the cushioning body 4 blocks transmittance of the electromagnetic wave (directed in a direction shown by an arrow C in FIG. 3) generated from a top portion of the HDD device 8. Further, the coating layer 7 (not shown) prevents a short circuit between the conductive ferrite particles 6 which are partially protruding from the lower surface of the bottom portion 4a of the cushioning body 4 and the wiring (not shown) of the main board 2.

Moreover, the cushioning body 4 protects the HHD device 8 from shock caused by vibrations during driving of the vehicle by its shock absorbing ability and quickly radiates heat generated by the HHD device 8 by means of its thermal conductivity, so that the HDD device 8 is not affected by the heat generated by itself. In addition, since the cushioning body 4 has heat resistance, it is not deformed by the heat generated by the HDD device 8 but surely holds the HDD device 8.

As described above, according to this embodiment 2, the cushioning body 4 is so arranged that the ferrite particles 6 are dispersedly distributed in the shock absorbing gel 5. Thus, this embodiment 1 produces an effect of surely eliminating the influence of vibrations and heat by the shock absorbing gel 5 and at the same time an effect of surely blocking the electromagnetic wave generated by the HDD device 8 which is arranged in the cushioning body 4 by the ferrite particles 6. In particular, according to this embodiment 2, since the cushioning body 4 is formed in the shape to cover the whole of the HDD device 8 because of its box shape with lid, it is possible to produce an effect of surely eliminating the influence of the electromagnetic wave generated in all directions from the HDD device 8 on the main board 2 and the board of the other device (not shown).

### EMBODIMENT 3

FIG. 4 is a schematic sectional view to show the structure of a cushioning body in accordance with embodiment 3 of the present invention. Here, of the constituent elements of this embodiment 3, elements common to the constituent elements of the embodiment 1 and the like are denoted by the same reference symbols and their further descriptions will be omitted.

The feature of this embodiment 3 lies in that a mixture (electromagnetic wave blocking member) 11 which is made by dispersing and mixing the ferrite particles (electromagnetic wave absorbing members) 6 in a shock absorbing oil 10, is wrapped by an outside skin 12 which is constituted of elastomer (heat resistant elastic member) such as rubber or the like thereby to form the cushioning body 4. In this embodiment 3, the ferrite particles 6 are wrapped by the outside skin 12, so even if the cushioning body 4 is directly placed on the main board 2, there is no fear that the mixture 11 will develop a short circuit with the main board 2. Therefore, it is not necessary to form a coating layer (not shown) on the lower surface of the bottom portion 4a of this cushioning body 4.

Next, operation will be described.

The electromagnetic wave generated by the HDD device 8 which is arranged in the cushioning body 4 impinges on the ferrite particles 6 which are uniformly dispersed in the outside skin 12 of the cushioning body 4, thereby being absorbed or reflected by the ferrite particles 6. Thus, the electromagnetic wave is blocked by the cushioning body 4, thereby being prevented from arriving at the main board 2.

Moreover, the cushioning body 4 protects the HHD device 8 from shock which is caused by vibrations during driving of the vehicle by its shock absorbing ability and quickly radiates heat generated by the HHD device 8 by means of its thermal conductivity, so that the HDD device 8 is not affected by heat generated by itself. In addition, since the cushioning body 4 has heat resistance, it is not deformed by the heat generated by the HDD device 8 but surely holds the HDD device 8.

As described above, according to this embodiment 3, the cushioning body 4 is structured in such a manner that the mixture (electromagnetic wave blocking member) 11 formed by dispersing and mixing the ferrite particles (electromagnetic wave absorbing members) 6 in the shock absorbing oil 10, is wrapped by the outside skin 12 constituted of an elastomer (heat resistant elastic member) such as rubber or the like. Thus, this embodiment 3 produces an effect of surely eliminating the influence of vibrations and heat by the shock absorbing oil 10 and the outside skin 12 and at the same time an effect of surely blocking the electromagnetic wave generated by the HDD device 8 which is arranged in the cushioning body 4 by the ferrite particles 6.

### EMBODIMENT 4

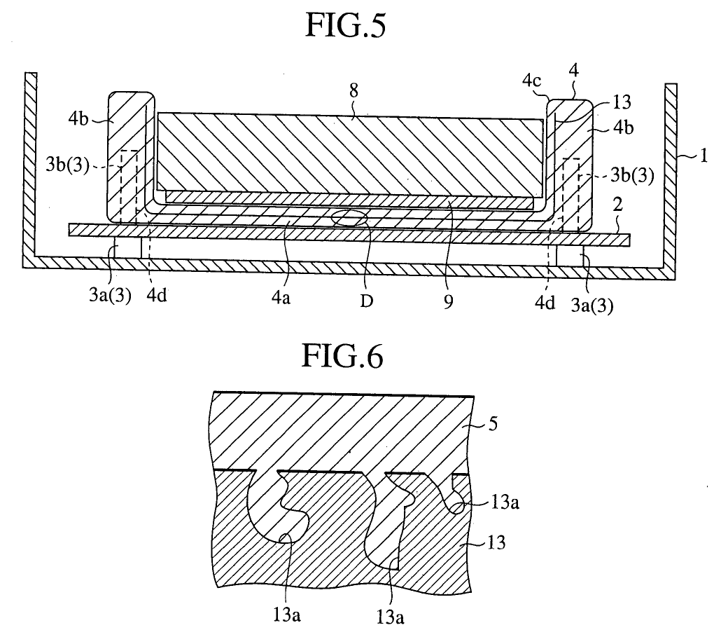

FIG. 5 is a schematic sectional view to show the structure of a cushioning body in accordance with embodiment 4 of the present invention. FIG. 6 is a schematic sectional view to show relevant portion D in FIG. 5 on an enlarged scale. At this point, of the constituent elements of this embodiment 4, elements common to the constituent elements of the embodiment 1 and the like are denoted by the same reference symbols and their further descriptions will be omitted.

The feature of this embodiment 4 lies in that a metal sheet (electromagnetic wave blocking member) 13 is arranged in the shock absorbing gel 5. That is, the metal sheet 13 is arranged in the box shaped cushioning body 4 in such a way that the metal sheet 13 is bent to locate from near the opening 4c above the wall 4b to near the opening 4c of the other wall 4b and to extend in the bottom portion 4a. As for materials to form the metal sheet 13, metal such as copper which has an effect of blocking the electromagnetic wave can be selected. And at the same time, the metal sheet 13 is required to have enough flexibility to be bent because it must be bent in a shape corresponding to that of the cushioning body 4.

Moreover, a surface roughening treatment is performed on the metal sheet 13 as shown in FIG. 6, by a method of etching or the like. This surface roughening treatment of the metal sheet 13 is given for the following purpose: when the shock absorbing gel 5 and the metal sheet 13 are formed, for example, polyurethane resin which constitutes the shock absorbing gel 5 is put into recessed portions 13a made by the surface roughening treatment of the metal sheet 13 thereby to prevent the shock absorbing gel 5 from being separated from the metal sheet 13 after forming.

Next, one example of a manufacturing method of the cushioning body 4 in this embodiment will be described.

First, the metal sheet 13 is put in a box shaped mold in a state where the metal sheet 13 is bent. Then, the polyurethane resin which constitutes the shock absorbing gel 5 is poured into the mold to form the cushioning body 4.

Next, operation will be described.

The electromagnetic wave generated by the HDD device 8 which is arranged in the cushioning body 4 impinges on the metal sheet 13 of the cushioning body 4, thereby being absorbed or reflected by the metal sheet 13. Thus, the electromagnetic wave is blocked by the cushioning body 4, thereby being prevented from arriving at the main board 2.

Moreover, the cushioning body 4 protects the HHD device 8 from shock caused by vibrations during driving of the vehicle by its shock absorbing ability and quickly radiates heat generated by the HHD device 8 by means of its thermal conductivity, so that the HDD device 8 is not affected by heat generated by itself. In addition, since the cushioning body 4 has heat resistance, it is not deformed by the heat generated by the HDD device 8 but surely holds the HDD device 8.

As described above, according to this embodiment 4, the cushioning body 4 is so arranged that the metal sheet 13 is put in the shock absorbing gel 5. Thus, this embodiment 4 produces an effect of surely eliminating the influence of vibrations and heat by the shock absorbing gel 5 and at the same time an effect of surely blocking the electromagnetic wave generated by the HDD device 8 which is arranged in the cushioning body 4 by the metal sheet 13.

At this point, the polyurethane which constitutes the shock absorbing gel 5 is poured into the outside of the metal sheet 13 and then it is molded to produce the cushioning body 4 in this embodiment 4. However, it is also recommended to adopt a manufacturing method of laminating two shock absorbing gels 5 on both surfaces of the metal sheet 13.

### EMBODIMENT 5

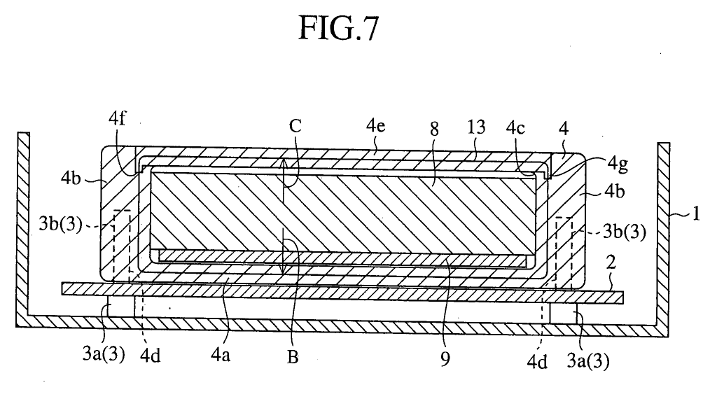

FIG. 7 is a schematic sectional view to show the structure of a cushioning body in accordance with embodiment 5 of the present invention. Here, of the constituent elements of this embodiment 5, elements common to the constituent elements of the embodiment 1 and the like are denoted by the same reference symbols and their further descriptions will be omitted.

The feature of this embodiment 5 lies in that different from the lidless box shaped cushioning body 4 in the embodiment 4, the cushioning body 4 is formed in a box with lid to cover the whole of HDD device 8. That is, the cushioning body 4 has a ceiling part 4e that is removably fitted in and engaged with the top of wall 4b constituting the opening 4c and closes the opening 4c. A depressed portion 4f is formed on the top of the wall 4b and a protruding portion 4g to be engaged with the depressed portion 4f is formed on the lower peripheral edge of the ceiling part 4e. At this point, the reason why the ceiling part 4e is provided, is to surely eliminate a possibility that when the top of the cushioning body 4 is open like the embodiment 1, the electromagnetic wave generated by the HDD device 8 passes from the opening 4c around the outside and may have an influence on the main board 2 or a board of the other device (not shown) arranged on an extending direction of the opening 4c. Moreover, in the cushioning body 4 in accordance with this embodiment 5, the metal sheet 13 is arranged in the whole of the shock absorbing gel 5. Here, the cushioning body 4 in accordance with this embodiment 5 can be manufactured by the similar method used in the embodiment 2. However, it is necessary that the metal sheet 13 in the ceiling part 4e and the metal sheet 13 in the wall 4b be correctly arranged so as to prevent a gap from being formed between both the metal sheets 13.

Next, operation will be described.

The electromagnetic wave generated in all directions by the HDD device 8 which is arranged in the cushioning body 4 impinges on the metal sheet 13 in the cushioning body 4, thereby being absorbed or reflected by the metal sheet 13. Thus, the electromagnetic wave is blocked.by the cushioning body 4, thereby being prevented from arriving at the main board 2.

As described above, according to this embodiment 5, the cushioning body 4 is formed in the shape to cover the whole of the HDD device 8. Thus, it is possible to produce an effect of surely eliminating the influence of the electromagnetic wave generated in all directions from the HDD device 8 on the main board 2 and the board of the other device (not shown) by the metal sheet 13.

### EMBODIMENT 6

The feature of this embodiment 6 lies in that a metal frame to fix the shock absorbing gel is used as the electromagnetic wave blocking member. That is, the metal frame which fixes the shock absorbing gel from the outside, is arranged on the outside of the shock absorbing gel formed in a predetermined shape that is suitable to contain the HDD device therein. As for a material for forming the metal frame a metal which has an effect of blocking the electromagnetic wave, such as copper, can be used and the metal frame is required to have flexibility and workability because it must be bent in a shape corresponding to that of the cushioning body 4.

At this point, since the metal frame is exposed to the outside of the cushioning body, the cushioning body is not directly placed on the main board but an insulating member is interposed between the main board and the cushioning body, or the cushioning body needs to be separated by a predetermined distance from the main board.

Next, one example of a manufacturing method of the cushioning body in this embodiment will be described

First, when the shock absorbing gel is formed in the shape of a box shown in FIG. 1, for example, the shock absorbing gel is poured into a space between the box shaped metal frame and a small box shaped mold frame arranged in this metal frame with a predetermined gap between them. Then, after the shock absorbing gel is molded, the inside mold frame is removed. In this manner, the shock absorbing gel is integrated with the above mentioned metal frame to fix the shock absorbing gel from the outside.

Next, operation will be described.

The electromagnetic wave generated by the HDD device which is arranged in the cushioning body impinges on the metal frame outside the cushioning body, thereby being absorbed or reflected by the metal frame. Thus, the electromagnetic wave is blocked by the cushioning body, thereby being prevented from arriving at the main board arranged directly below the cushioning body.

As described above, according to this embodiment 6, the metal frame to fix the shock absorbing gel is used as the electromagnetic wave blocking member. Thus, it is possible to produce an effect of surely eliminating the influence of vibrations and heat by the shock absorbing gel and at the same time an effect of surely blocking the electromagnetic wave generated from the HDD device arranged in the cushioning body by the metal frame as the electromagnetic wave blocking member.

In this regard, the cushioning bodies in accordance with from the embodiment 1 to the embodiment 6 can be combined with a conventional shock absorbing member. In these cases, the shock absorbing member can be reduced in strength and thus in size, so it is possible to produce an effect of reducing the cost of the shock absorbing member.

What is claimed is:

1. A cushioning body comprising:
a heat resistant elastic member arranged around an electromagnetic wave generating unit; and
an electromagnetic wave blocking member arranged in the heat resistant elastic member.

2. The cushioning body as claimed in claim 1, wherein the electromagnetic wave blocking member is ferrite particles dispersed in the heat resistant elastic member.

3. The cushioning body as claimed in claim 2, wherein the ferrite particles are locally distributed in the heat resistant elastic member.

4. The cushioning body as claimed in claim 1, wherein the electromagnetic wave blocking member is a mixture of a shock absorbing oil and an electromagnetic wave absorbing member and is wrapped by an outside skin formed of the heat resistant elastic member.

5. The cushioning body as claimed in claim 1, wherein the electromagnetic wave blocking member is a metal sheet arranged in the heat resistant elastic member.

6. The cushioning body as claimed in claim 5, wherein the metal sheet has a roughened surface.

7. A cushioning body comprising:
a heat resistant elastic member arranged around an electromagnetic wave generating unit; and
an electromagnetic wave blocking member, wherein
the heat resistant elastic member is made of shock absorbing gel; and
the electromagnetic wave blocking member is a metal frame for fixing the shock absorbing gel.
